(19) United States
(12) Patent Application Publication
(10) Pub. No.: US 2026/0219140 A1
(43) Pub. Date: Jul. 30, 2026

(54) SCOOP PROBE

(71) Applicant: INSIGHT ANALYTICAL SOLUTIONS INC, Calgary (CA)

(72) Inventors: Philip C. HARRIS, Calgary (CA); Kevin HARRIS, Calgary (CA)

(21) Appl. No.: 19/141,226

(22) PCT Filed: Dec. 22, 2023
(86) PCT No.: PCT/CA2023/051753

§ 371 Date: Jun. 19, 2025

Related U.S. Application Data
(60) Provisional application No. 63/435,126, filed on Dec. 23, 2022.

(51) Int. Cl. G01N 1/22; G01N 1/20

(52) U.S. Cl. CPC G01N 1/2247; G01N 1/2035; G01N 2001/2285

(57) ABSTRACT

A probe tip for a sample retrieval system includes a hollow body. The body includes an inlet port formed in one end of the body and including an opening for facing a process flow to receive a sample of a process fluid. The inlet passage has a non-constant cross-sectional area with non-parallel radii of curvature defined by an outer radius of the inlet passage that is larger than an inner radius of the inlet passage. The outer radius decreases along a length of the inlet port from the opening. An inlet tube is in fluid communication with the inlet port and receives the sample from the inlet port. An outlet tube is connected to the body to receive a returned portion of the sample. An exit port is formed in the body to expel the returned sample into the process flow.

### CROSS-REFERENCE TO RELATED APPLICATIONS

This application claims the benefit and priority of U.S. Provisional Application 63/435,126, filed Dec. 23, 2022. The foregoing application is incorporated by reference herein in its entirety.

### FIELD OF THE INVENTION

The present invention pertains to the field of analytical measurements for process control and in particular to sampling a process fluid to be extracted and sent to an analyzer.

### BACKGROUND

Some analytical measurements for process control and emissions monitoring in the oil & gas and chemical process industries can be done in situ, but most require a representative sample of the process fluid to be extracted and transported to an analyzer. The most common method of extracting sample gas from high pressure processes for analytical measurements is to the reduce the pressure of the sample before measurement and then to vent the gas to a low pressure vent. In these cases it is typically not feasible to return the sample to process. In some cases if the analysis can be done at a relatively higher pressure and if a sufficiently high pressure differential is available in the process and there are sample point connections available at both the low and high pressure sides across the pressure differential, then the sample can be drawn from the high pressure side and then returned to the low pressure side of the process after analysis. In cases where the analysis can be done at a high pressure, but there is not a sufficient pressure differential available in the process, then it may be possible to use a pump to sample and return the sample back to the process, however this still requires two sample points and the expense and maintenance involved with a pump.

Scoop probes (sometimes called flow impact probes) may be used to extract a sample from a process flow. However, present-day scoop probes suffer the drawbacks of generating a very small pressure differential and having an internal geometry that is not optimal for maximizing flow rates, especially for applications with viscous liquids and low process velocities. Present-day scoop probes also tend to be expensive, very orientation-sensitive, and available in only a limited range of process-connection sizes (2″ or larger flanges, or ¾″ National Pipe Thread (NPT) or larger for single-point sample and return versions).

Therefore, there is a need for a scoop probe and scoop probe assembly that obviates or mitigates one or more limitations of the prior art, such as working in a wide variety of applications, including those with cost limitations, small process-connection sizes, low process velocities, and high-viscosity liquids, without the need for a pump.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a probe tip for a sample retrieval system including an inlet pipe and an outlet pipe. The probe tip includes an elongated, hollow body having a distal end, a proximal end, and a central axis. The body includes an inlet port formed in the distal end of the body, where the inlet port includes an opening in a distal portion of the body for facing a process flow to receive a sample of a process fluid from the process flow. The inlet port includes an inlet passage directing the sample in a direction along the central axis towards a proximal portion of the inlet port. The inlet passage has a non-constant cross-sectional area with non-parallel radii of curvature defined by an outer radius and an inner radius. The outer radius of the inlet passage is larger than the inner radius of the inlet passage, and the outer radius decreases along a length of the inlet port from the opening to the proximal portion. An inlet tube is in fluid communication with the proximal portion of the inlet port and is configured to receive the sample from the inlet port and direct the sample towards the proximal end of the body to be received by the inlet pipe. An outlet tube is connected to the proximal end of the body and is configured to receive a returned portion of the sample from the outlet pipe. An exit port is formed in the body and is configured to be in fluid communication with the outlet tube to receive the returned portion of the sample from the outlet tube and expel the sample into the process flow in a direction away from the process flow. The exit port is located at a position closer to the proximal end of the probe tip than a position of the inlet port.

In accordance with another aspect of the present invention, there is provided a probe tip assembly including a probe tip as described herein, an inlet pipe attached to the inlet tube, and an outlet pipe attached to the outlet tube.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which;

FIG. 1 illustrates a multi-view drawing of a scoop probe, according to an embodiment.

FIG. 2 illustrates a front view and a cross-sectional view of a scoop probe, according to an embodiment.

FIG. 3 illustrates an isometric view of a scoop probe, according to an embodiment.

FIG. 4 illustrates a multi-view drawing of a compact-style scoop probe, according to an embodiment.

FIG. 5 illustrates a front view and a cross-sectional view of a compact-style scoop probe, according to an embodiment.

FIG. 6 illustrates a front view and an isometric view of a compact-style scoop probe, according to an embodiment.

FIG. 7 illustrates a multi-view drawing of a rotatable-shaft-style scoop probe, according to an embodiment.

FIG. 8 illustrates a front view and a cross sectional view of a rotatable-shaft-style scoop probe, according to an embodiment.

FIG. 9 illustrates a front view and an isometric view of a rotatable-shaft-style scoop probe, according to an embodiment.

FIG. 10 illustrates a cross sectional view of a scoop probe with connected inlet and outlet pipes, according to an embodiment.

FIG. 11 illustrates multiple cross-sectional views and an isometric view of a flange-style of scoop probe with connected inlet and outlet pipes, according to an embodiment.

FIG. 12 illustrates multiple views of a scoop probe with connected inlet and outlet pipes, according to an embodiment.

FIG. 13 illustrates a scoop probe assembly as used to extract a sample from a process flow, according to an embodiment.

It will be noted that throughout the appended drawings, like features are identified by like reference numerals.

### DETAILED DESCRIPTION OF THE INVENTION

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

Embodiments of the present invention provide a probe tip for a sample retrieval system including an inlet pipe and an outlet pipe. The probe tip includes an elongated, hollow body having a distal end, a proximal end, and a central axis. The body includes an inlet port formed in the distal end of the body. The inlet port includes a scoop-like opening in a distal portion of the body for facing a process flow to receive a sample of a process fluid from the process flow (referred to herein as the sample or process flow sample). The inlet port includes an inlet passage directing the sample in a direction along the central axis towards a proximal portion of the inlet port. The inlet passage has a non-constant cross-sectional area with non-parallel radii of curvature. An outer radius of the inlet passage is larger than an inner radius of the inlet passage. The outer radius decreases along a length of the inlet port from the opening to the proximal portion. An inlet tube is in fluid communication with the proximal portion of the inlet port and is configured to receive the sample from the inlet port and direct the sample towards the proximal end of the body such that the sample is received by the inlet pipe. An outlet tube is connected to the proximal end of the body configured to receive a returned portion of the sample from the outlet pipe. An exit port is formed in the body and is configured to be in fluid communication with the outlet tube to receive the returned portion of the sample from the outlet tube and expel the sample into the process flow in a direction away from the process flow. The exit port is located at a position closer to the proximal end of the probe tip than a position of the inlet port.

In further embodiments, the inlet opening has an elliptical shape with a semi-major axis of the ellipse approximately aligned with the central axis.

In further embodiments, the inlet tube is arranged within the outlet tube.

In further embodiments, the inlet tube and the outlet tube are in a coaxial arrangement.

In further embodiments, the exit port is positioned on a side of the body facing away from the inlet port. In some embodiments, the exit port is located at about a 90° angle relative to a direction of the process flow to the process flow. In some embodiments, the exit port is located on a side of the probe tip opposite from the inlet port.

In further embodiments, the exit port is at a position corresponding to a widest diameter of the body of the probe tip.

Some embodiments further include an additional exit port arranged on a side of the body opposite from the exit port, where the additional exit port is facing away from the inlet port. In some embodiments, the additional exit port is located at about a 90° angle relative to a direction of the process flow.

Some embodiments further include a cross-sectionally annular area between the inlet tube and the outlet tube with baffles that are aligned with the central axis and configured to prevent flow between the exit port and the additional exit port.

In some embodiments, a cross-sectional area of the inlet tube and a cross-sectional area of the outlet tube are similar. In some embodiments, a cross-sectional area of the inlet tube and a cross-sectional annular area between the inlet tube and the outlet tube are similar. This similarity may balance the volume of process flow in the inlet tube and in the outlet tube.

In further embodiments, the inlet port has a distal outer surface that is tangential to the process flow.

In further embodiments, a proximal end of the inlet tube is tapered to be received by the inlet pipe, an inside diameter of the inlet pipe being sealed against the tapered proximal end of the inlet tube via a force from a compression fitting located at the proximal end of the inlet tube, or pipe seals against the OD of the taper.

In further embodiments, an outside diameter of the proximal end of the probe is matched to an inside diameter of the outlet pipe.

Some embodiments of the present invention provide a probe tip assembly including the probe tip as described herein, an inlet pipe attached to the inlet tube, and an outlet pipe attached to the outlet tube.

Some embodiments further include a T fitting connected to a proximal end of the outlet pipe opposite the probe tip. A perpendicular opening of the T fitting is aligned in the same plane as the opening of the probe tip, and the T fitting secures the inlet pipe to the inlet tube.

Some embodiments further include a flange for securing the probe tip assembly wherein the probe tip is positioned within the process flow with the opening facing an opposite direction of flow of the process fluid.

Embodiments further include a bored-through compression fitting for securing the probe tip assembly wherein the probe tip is positioned within the process flow with the opening facing an opposite direction of flow of the process fluid.

Embodiments provide economical single-point sample and return scoop probes that are designed to maximize both a pressure differential generated for a given process fluid density and velocity and an internal flow rate that is induced by the available pressure differential. Embodiments may be compatible with installations with either flanged or threaded process connections including 1″, ¾″ and ½″ National Pipe Thread (NPT), and with both gas and liquid phase applications over a wide range of pipe sizes and process fluid densities and velocities.

Embodiments can receive a process flow sample by inducing a pressure differential using the process fluid velocity without the need for pumps or additional equipment. The flowing process fluid has kinetic energy proportional to the density and the square of the velocity. When the moving process fluid encounters the scoop-like opening at the front of the probe tip, it is forced to slow down, thereby converting the kinetic energy of the process flow to an increase in pressure. Process fluid above the front opening is forced to flow around the probe, which increases the velocity and lowers the pressure around the exit port(s). The resulting pressure differential between the front opening and the exit port(s) on the side of the probe can be used to generate a sample flow in an external fast loop, propelling the sample through the input pipe to an analyzer and then returning the sample to the process flow via the probe.

Embodiments may be fabricated as a solid piece of material by a variety of means, including 3D printing, casting, or machining, which allow more flexibility in the design of the geometry of the scoop probe than fabrication means involving bending and welding tubing. This additional design flexibility allows the design of the scoop probe to be optimized to generate higher pressure differentials, induce higher flow rates, and be less sensitive to orientation of the scoop probe with respect to process flow than previous designs.

Embodiments may be varied in a number of ways for different applications and characteristics of the process flow. Changing the size and shape of the elliptical inlet opening of the inlet port may both increase the induced pressure differential and reduce orientation sensitivity. The ability to create embodiments with different geometries for the inlet opening makes it possible to create probes for small process pipes; for example, an elliptical opening with a transverse semi-major axis, rather than one aligned with the central axis, may need to be inserted less far into the process flow.

Embodiments may have internal passages contoured on both the inlet port and exit ports (which may also be referred to as return vents or vent slots) of the scoop probe. The internal passages may include features such as bends with non-parallel and non-constant radii of curvature, gradual tapers, or transitions, chamfers, and radii to provide higher flow rates by reducing pressure drops. The internal passages may be important for process flows that include viscous liquids. Non-parallel and non-constant radii of curvature can also provide higher pressure differentials by keeping the first section of the inlet passage closer to horizontal.

Embodiments may connect the inlet pipe to the probe tip by forcing the inside of the inlet pipe over a taper on the probe tip, thereby eliminating the extra welding of previous designs, which simplifies assembly, lowers cost, and allows replacement of the inside tube if required.

In embodiments, the exit port and additional exit port on the sides of the probe tip may be located at approximately 90° to the baffles in the probe tip to eliminate cross flow between the two exit ports that can be created by small pressure differentials between the two sides of the probe tip. These baffles reduce performance sensitivity to probe orientation by allowing the exit ports to function independently.

Embodiments can have an internal shaft (herein referred to as the shaft) installed in the body of the probe tip that allows the probe tip to be rotated for alignment with a process flow before locking in place with a locknut or other locking means. This makes it possible to align the probe tip when a process is pressurized, which may not be possible with tubing-style probes installed with a compression fitting. The probe shaft can be welded to the probe tip. Grooves on an outside diameter (OD) of the shaft allow the process fluid flowing through the probe to be routed through optional isolation valves.

Embodiments will now be described with reference to specific examples. It will be understood that the following examples are intended to describe embodiments of the invention and are not intended to limit the invention in any way.

### EXAMPLES

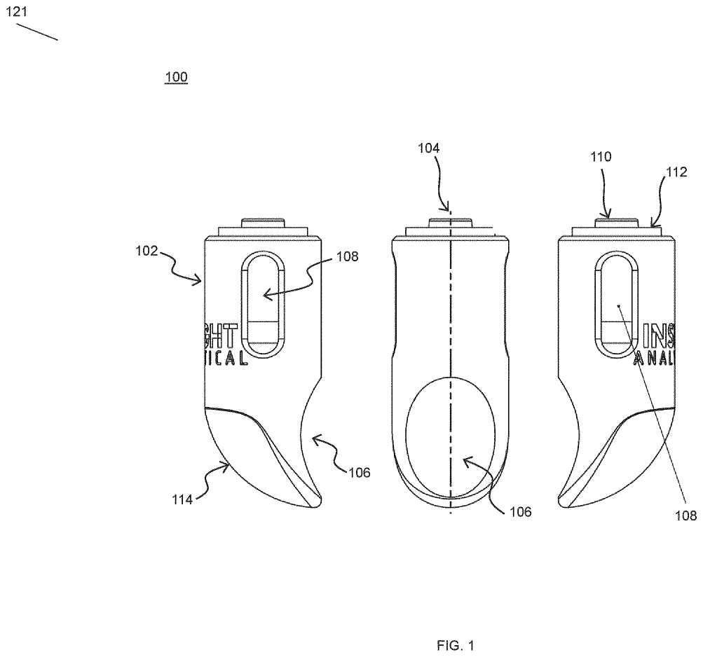

With reference to FIG. 1, multiple views of a probe tip 100 are illustrated. The probe tip 100 may have an elongated, hollow body 102, that may be cylindrical, and include a central axis 104. In embodiments, the probe tip may be mounted so that it is oriented in any direction such as horizontally, or in an upwards vertical direction.

The probe tip 100 is designed to be placed within a process flow, oriented so that an inlet port 106 is facing the process flow in order to collect a sample from the process flow. Preferably, a plane of an opening of the inlet port 106 is perpendicular or close to perpendicular to the process flow. The opening may have an elliptical shape with the semi-major axis aligned with the central axis 104. However, the opening of inlet port 106 may have other shapes. A distal outer surface 114 of the inlet port 106 may be curved from a bottom point of the probe tip 100 to a direction aligned with the central axis 104. An inner, distal portion of the inlet port 106 may be as close as possible to a plane perpendicular to the central axis 104; this maximizes stagnation pressure by slowing down the oncoming process flow to best effect without having the process flow tending to slip underneath the probe tip 100. The geometry of the opening of the inlet port 106, in combination with that of the distal outer surface 114, can make the opening scoop-like. One or more exit ports 108 may be formed in the body 102 to expel part of the collected sample to the process flow. Exit ports 108 may be placed at the side of the body 102 on one or both sides. Preferably, each exit port 108 is placed at right angles to the process flow, or at least away from the direction of process flow. Having two exit ports 108, rather than one exit port 108, improves flow through the probe (loop flow) because the increased exit area reduces flow resistance. Having two exit ports 108 also makes the probe less sensitive to orientational misalignment. The exit area of each exit port 108 should be sufficiently narrow to minimize locating portions of the opening away from the area of lowest pressure and should be sufficiently short to minimize the probe tip 100 length and avoid locating the upper part of the exit port 108 too close to a pipe wall containing the process flow, where the process velocity is lower.

In other words, the inlet port 106 may face the process flow while exit ports 108 may be located at the sides or rear of the body 108 facing away from the process flow. In embodiments, an exit port 108 may also be placed opposite the inlet port 106 and expel sample in the direction of the process flow.

Probe tip 100 can be used in applications to induce a pressure differential using the process fluid velocity, without the need for pumps or additional equipment. Flowing process fluid has kinetic energy proportional to the density of the process fluid and the square of its velocity. When the moving process fluid encounters the scoop-like opening of the inlet port 106, it is forced to slow down, converting its kinetic energy to an increase in pressure. Process fluid above the inlet port 106 is forced to flow around the probe tip 100, which increases the velocity and lowers the pressure around the exit ports 108. The resulting pressure differential between the inlet port 106 and the exit ports 108 on the side of the probe can be used to generate sample flow in an external fast loop.

An important aspect of probe tip 100 is where and how the kinetic energy of the process fluid flow is used to induce a pressure differential. The size of the probe tip 100 may be dictated by the available opening size of the connection to the process connection and by the diameter of the pipe carrying the process flow (i.e., the process pipe) as well as considerations in keeping the mass of the probe tip 100 low to avoid resonance issues induced by vortex shedding. In one configuration, the outside diameter of the probe tip 100 is chosen to be the same or slightly larger than an outlet pipe that it can be welded to.

Inlet port 106 is coupled to an inlet tube 110 to deliver the sample for extraction or analysis. Similarly, each exit port 108 is coupled to an outlet tube 112. In the embodiment of FIG. 1, inlet tube 110 and outlet tube 112 are arranged coaxially. The diameters and thicknesses of inlet tube 110 and outlet tube 112 may be selected based on the external process connection size and with the goal of having a similar cross-sectional area and flow resistance for the inside of the inlet tube 110 and the annular area formed by the inside of the outlet tube 112 and the inlet tube 110. Inlet tube 110 and outlet tube 112 are configured to connect to external pipes and may be connected to said external pipes using methods such as welding or compression fittings.

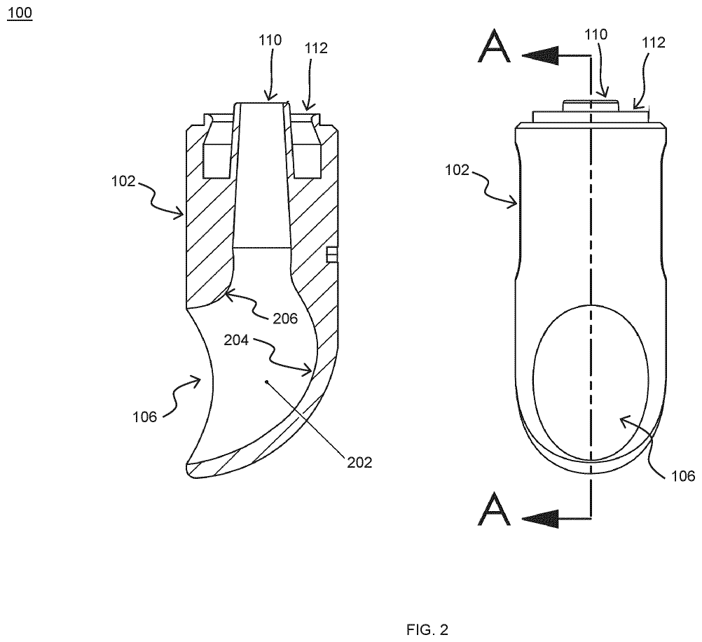

FIG. 2 shows a front view of probe tip 100 together with a cross-sectional view of probe tip 100 through location A-A. Inlet port 106 leads to an inlet passage 202 directing the received sample in a direction along the central axis 104. As illustrated, the inlet passage 202 has a cross-sectional area that is elliptical in shape, and has an outer wall 204 and inner wall 206, with a radius of the outer wall 204 being larger than a radius of the inner wall 206. The area of the opening of the inlet port 206 smoothly transitions to the area of the inlet tube 110 through the inlet passage 202. A decrease in pressure of the process fluid in the inlet passage 202 can be minimized by making the radius of the outer wall 204 much larger than if the bends of the outer wall 204 and the inner wall 206 were parallel, because the flow of the process fluid preferentially moves to the outside of the curve when transitioning to flowing in the direction of the central axis 104. In other words, the inlet passage 202 may have a non-constant cross-sectional area with non-parallel radii of curvature, with the radius of the outer wall 204 being larger than the radius of the inner wall 206.

A front opening of the inlet port 106 with a larger cross-sectional area than the area of the central tube (the inlet passage 202 and inlet tube 110) ensures that the front opening of the inlet port 106 is not the limiting factor in supplying sample flow and also maintains sufficient opening area even when the probe tip 100 is rotationally misaligned from the optimum of directly facing the process flow by up to 30°.

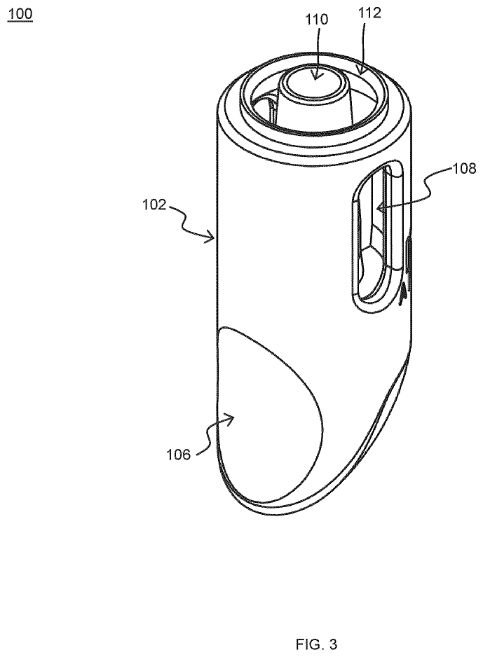

An isometric view of the probe tip 100 of FIG. 1 and FIG. 2 is shown in FIG. 3.

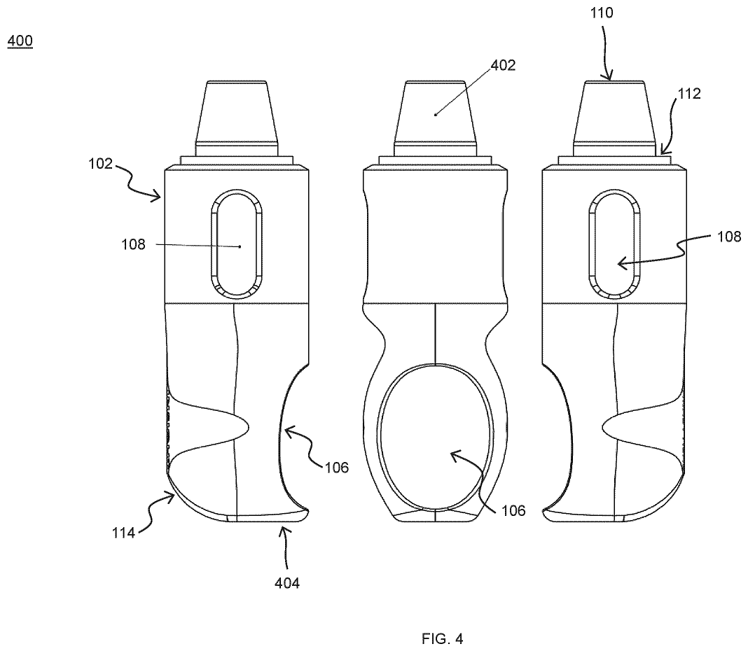

With reference to FIG. 4, multiple views of a probe tip 400 are illustrated. The probe tip 400 may have a cylindrical body 102 that can be oriented vertically or horizontally and that has a central axis. The probe tip 400 is designed to be placed within a process flow, oriented so that an inlet port 106 of the probe tip 400 is facing the process flow in order to collect a sample from the process flow. Preferably, a plane of a scoop-like opening of the inlet port 106 is perpendicular or close to perpendicular to the process flow. The opening may have an elliptical shape with the semi-major axis aligned with the central axis. However, the opening of the inlet port 106 may have other shapes. A distal outer surface 404 of the inlet port 106 may be substantially parallel to the process flow, which may aid in fitting the probe tip 400 into a process flow with little available space perpendicular to the process flow. The probe tip 400 has an outer surface 114 with a portion in proximity to inlet port 106 that may be as close as possible to the direction of process flow. An inner, distal portion of the inlet port 106 may have a surface that is as parallel as possible to the direction of process flow to maximize stagnation pressure by slowing down the oncoming process flow to best effect without having the process flow tend to slip down underneath the probe tip 400. One or more exit ports 108 may be formed in the body 102 to expel part of the collected sample to the process flow. Exit ports 108 may be placed at the side of the body 102 on one or both sides. Preferably, each exit port 108 is placed at right angles to the process flow. Having two side exit ports 108 increases loop flow by reducing flow resistance because of the increased exit area, and this also makes the probe tip 400 less sensitive to orientational misalignment. The exit area of each exit port 108 should be sufficiently narrow to minimize locating portions of the opening away from the area of lowest pressure and should be sufficiently short to minimize the probe tip 100 length and avoid locating the upper part of the exit port 108 too close to a pipe wall containing the process flow, where the process velocity is lower.

In other words, the inlet port 106 may face the process flow while exit ports 108 may be located at the sides of the body 108. In embodiments, an exit port 108 may also be placed opposite the inlet port 106 and expel sample in the direction of the process flow.

Probe tip 400 can be used in applications to induce a pressure differential using the velocity of the process fluid, without the need for pumps or additional equipment. Flowing process fluid has kinetic energy proportional to the density of the process fluid and the square of its velocity. When the moving process fluid encounters the scoop-like opening of the inlet port 106 at the front of the probe tip 400, it is forced to slow down, converting its kinetic energy to an increase in pressure. Process fluid above the inlet port 106 is forced to flow around the probe tip 400, which increases the velocity and lowers the pressure around the exit ports 108. The resulting pressure differential between the inlet port 106 and the exit ports 108 on the side of the probe can be used to generate sample flow in an external fast loop.

An important aspect of probe tip 400 is where and how the kinetic energy of the process fluid flow is used to induce a pressure differential. The size of the probe tip 400 may be dictated by the available opening size in the process connection and by the diameter of the process pipe as well as considerations in keeping the mass of the probe tip 400 low to avoid resonance issues induced by vortex shedding. In one configuration, the outside diameter of the probe tip 100 is chosen to be the same or slightly larger than an outlet pipe that it can be welded to.

Inlet port 106 is coupled to an inlet tube 110 to deliver the sample for extraction or analysis. Similarly, each exit port 108 is coupled to an outlet tube 112. In the embodiment of FIG. 4, inlet tube 110 and outlet tube 112 are arranged coaxially. The diameters and thicknesses of inlet tube 110 and outlet tube 112 may be selected based on the external process connection size and with the goal of having a similar cross-sectional area and flow resistance for the inside of the inlet tube 110 and the annular area formed by the inside of the outlet tube 112 and the inlet tube 110. Inlet tube 110 and outlet tube 112 are configured to connect to external pipes using compression fittings. Inlet tube 110 terminates in a tapered outlet 402 to enable a connection to an external pipe. The inlet tube 110 and outlet tube 112 may also be configured to be connected in different ways, for example, through welding. A combination of techniques may also be used; for example, a compression fitting may be used to connect an internal pipe to inlet tube 110 while welding may be used to connect an external pipe to outlet tube 112.

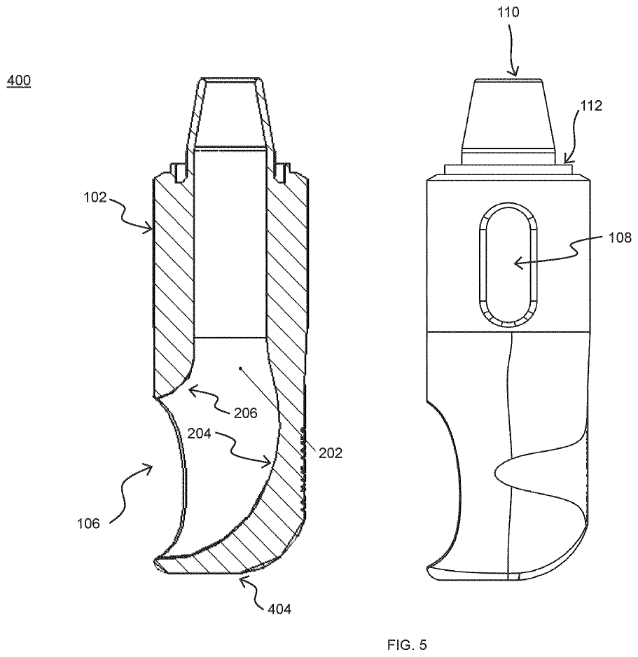

FIG. 5 shows a side view of probe tip 400 together with a corresponding cross-sectional view of probe tip 400. Inlet port 106 leads to an inlet passage 202 directing the received sample in a direction along the central axis. As illustrated, the inlet passage 202 has an elliptical cross section and an outer wall 204 and an inner wall 206, with the radius of the outer wall 204 being larger than the radius of the inner wall 206. The area of the opening of the inlet port 206 smoothly transitions to the area of the inlet tube 110 through the inlet passage 202. A decrease in pressure of the process fluid in the inlet passage 202 can be minimized by making the radius of the outer wall 204 much larger than if the bends of the outer wall 204 and the inner wall 206 were parallel, because the flow of the process fluid preferentially moves to the outside of the curve when transitioning to flowing in the direction of the central axis.

A front opening 106 with a larger cross-sectional area than the area of the central tube (the inlet passage 202 and the inlet tube 110) ensures that the front opening 106 is not the limiting factor in supplying sample flow and also maintains sufficient opening area even when the probe tip 400 is rotationally misaligned from the optimum of directly facing the process flow by up to 30°.

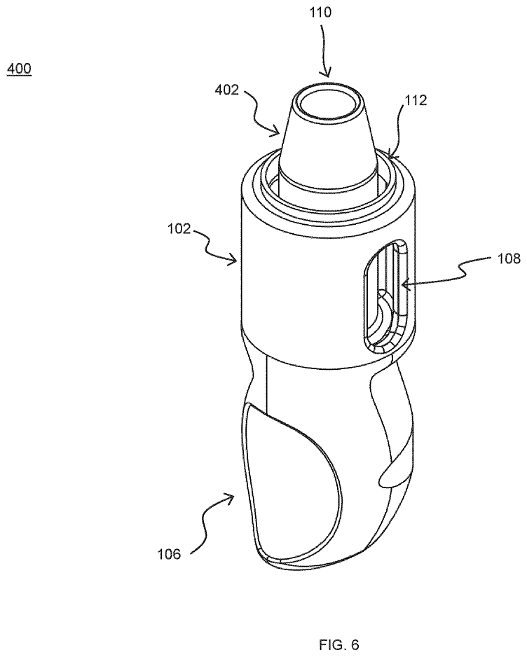

An isometric view of the probe tip 400 of FIG. 4 and FIG. 5 is shown in FIG. 6 illustrating the tapered outlet 402 that may be used to connect inlet tube 110 to another pipe.

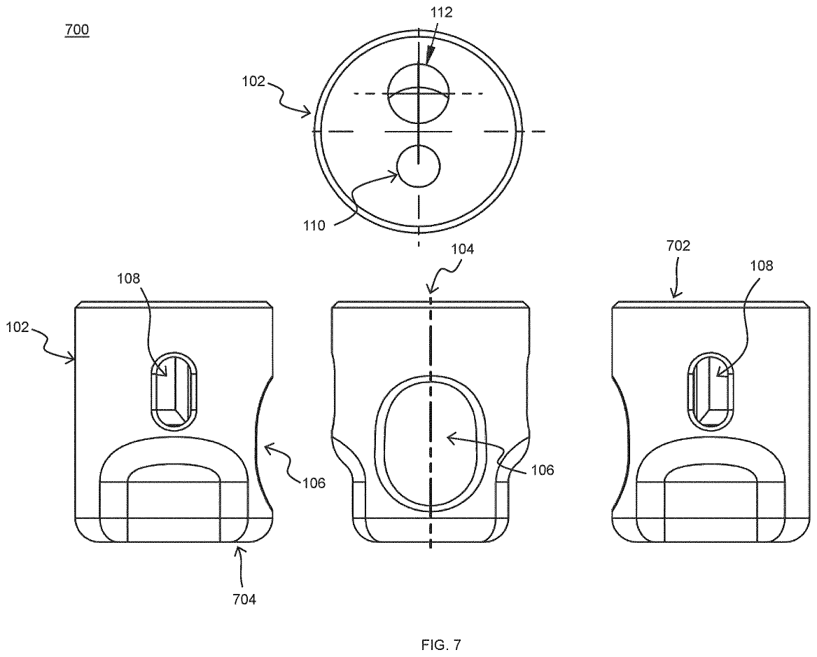

With reference to FIG. 7, multiple views of a probe tip 700 are illustrated, including a planar view of a proximal portion of probe tip 700. The probe tip 700 may have a cylindrical body 102 and a central axis 104. The probe tip 700 is designed to be placed within a process flow, oriented so that an inlet port 106 of the probe tip 700 is facing the process flow in order to collect a sample from the process flow. Preferably, a plane of a scoop-like opening of the inlet port 106 is perpendicular or close to perpendicular to the process flow. The opening may have an elliptical shape with the semi-major axis aligned with the central axis 104. However, the opening of inlet port 106 may have other shapes. A distal outer surface 704 (i.e., a bottom surface of the probe tip 700) of the inlet port 106 may be substantially parallel to the process flow, which may aid in fitting the probe tip 700 into a process flow with little available space perpendicular to the direction of the process flow. The distal outer surface 704 of probe tip 700 may form a planar lower surface perpendicular to the central axis 104. An inner, distal portion of the inlet port 106 may further have a surface perpendicular to the central axis 104. This maximizes stagnation pressure by slowing down the oncoming process flow to best effect without having the process flow tend to slip down underneath the probe tip 700. One or more exit ports 108 may be formed in the body 102 to expel part of the collected sample to the process flow. Exit ports 108 may be placed at the side of the body 102 on one or both sides. Preferably, each exit port 108 is placed at right angles to the process flow. Having two side exit ports 108 increases loop flow by reducing flow resistance because of the increased exit area, and this also makes the probe tip 700 less sensitive to orientational misalignment. The exit area of each exit port 108 should be sufficiently narrow to minimize locating portions of the opening away from the area of lowest pressure and should be sufficiently short to minimize the probe tip 100 length and avoid locating the upper part of the exit port 108 too close to a pipe wall containing the process flow, where the process velocity is lower.

In other words, the inlet port 106 may face the process flow while exit ports 108 may be located at the sides of the body 108. In embodiments, an exit port 108 may also be placed opposite the inlet port 106 and expel sample in the direction of the process flow.

Probe tip 700 can be used in applications to induce a pressure differential using the process fluid velocity, without the need for pumps or additional equipment. Flowing process fluid has kinetic energy proportional to the density of the process fluid and the square of its velocity. When the moving process fluid encounters the scoop-like opening of the inlet port 106 at the front of the probe tip 700, it is forced to slow down, converting its kinetic energy to an increase in pressure. Process fluid above the inlet port 106 is forced to flow around the probe, which increases the velocity and lowers the pressure around the exit ports 108. The resulting pressure differential between the inlet port 106 and the exit ports 108 on the side of the probe tip 700 can be used to generate sample flow in an external fast loop.

An important aspect of probe tip 700 is where and how the kinetic energy of the process fluid flow is used to induce a pressure differential. The size of the probe tip 700 may be dictated by the available opening size in the process connection and by the diameter of the process pipe as well as considerations in keeping the mass of the probe tip 700 low to avoid resonance issues induced by vortex shedding.

Inlet port 106 is coupled to an inlet tube 110 to deliver the sample for extraction or analysis. Similarly, each exit port 108 is coupled to an outlet tube 112. In the embodiment of FIG. 7, inlet tube 110 and outlet tube 112 are arranged linearly rather than coaxial as with the other types of probe tips described herein. This arrangement simplifies a gas flow connection to the probe tip 700 and the attachment of multiple valves. In other variations of probe tip 700, the inlet tube 110 and outlet tube 112 may be arranged coaxially. The diameters and thicknesses of inlet tube 110 and outlet tube 112 may be selected based on the external process connection size and with the goal of outlet tube 112 having a similar or larger cross-sectional area to inlet tube 110. Inlet tube 110 and outlet tube 112 are configured to connect to external pipes using compression fittings, welding, or other connection. A combination of techniques may also be used to connect pipes to each of inlet tube 110 and outlet tube 112.

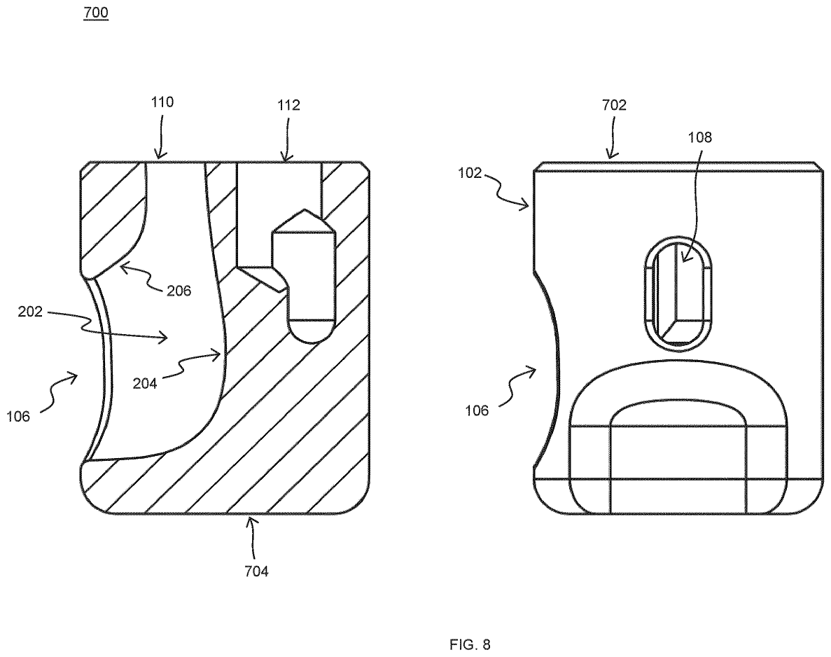

FIG. 8 shows a side view of probe tip 700 together with a corresponding cross-sectional view of probe tip 700. Inlet port 106 leads to an inlet passage 202 directing the received sample in a direction along the central axis 104. As illustrated, the inlet passage 202 has an elliptical cross section, and an outer wall 204 and an inner wall 206, with a radius of the outer wall 204 being larger than a radius of the inner wall 206. The area of the opening of the inlet port 206 smoothly transitions to the area of the inlet tube 110 through the inlet passage 202. A decrease in pressure of the process fluid in the inlet passage 202 can be minimized by making the radius of the outer wall 204 much larger than if the bends of the outer wall 204 and the inner wall 206 were parallel, because the flow of the process fluid preferentially moves to the outside of the curve when transitioning to flowing in the direction of the central axis 104.

An opening of the inlet port 106 with a larger cross-sectional area than the area of the central tube (inlet passage 202 and inlet tube 110) ensures that the opening of the inlet port 106 is not the limiting factor in supplying sample flow and also maintains sufficient opening area even when the probe tip 700 is orientationally misaligned by up to 30° from the optimal orientation of directly facing the process flow.

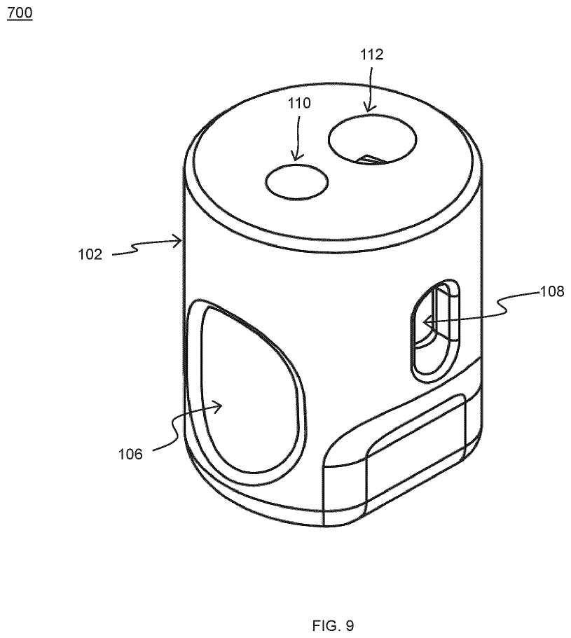

An isometric view of the probe tip 700 of FIG. 7 and FIG. 8 is shown in FIG. 9.

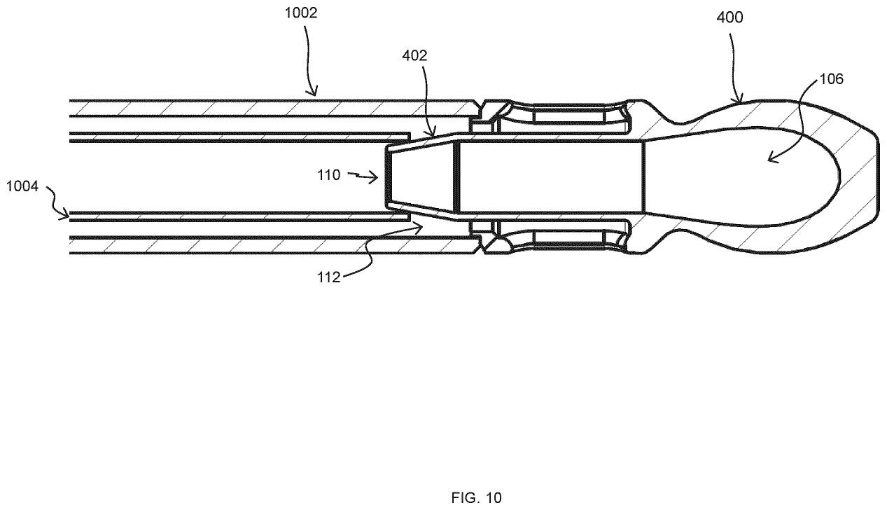

FIG. 10 shows a cross-sectional view of a scoop probe tip connected with an external inlet pipe 1004 and an external outlet pipe 1002. FIG. 10 has been illustrated with probe tip 400 shown; however, other probe tips such as probe tip 100 or probe tip 700 may be substituted. The probe tip may include an inlet tube 110 that includes a tapered outlet 402 for connecting the inlet tube 110 to the inlet pipe 1004. Outlet tube 112 may be welded to the outlet pipe 1002. As illustrated, inlet pipe 1004 and outlet pipe 1002 are arranged coaxially with the inlet pipe 1004 positioned within the outlet pipe 1002. FIG. 10 depicts a 1″ pipe embodiment wherein the outlet pipe 1002 is 1″ schedule 40 stainless steel and the inlet pipe 1004 tube is ¾″ 0.065″ wall thickness stainless steel tubing; however, other sizes of pipe can be used. The inlet pipe 1004 may be constructed from other materials such as Hastelloy, Inconel, Monel, and aluminum.

For assembly, the outlet tube 112 of probe tip 400 may be welded onto the outlet pipe 1002. Once the welding is complete, the compression fittings and inlet pipe 1004 can be installed. The inlet pipe 1004 may be installed by sliding it through an upper compression fitting and aligning and pushing it down onto the probe tip tapered outlet 402. As the compression fitting is tightened, the bottom end of the inlet pipe 1004 is forced further onto the compression tapered outlet 402 which creates a seal.

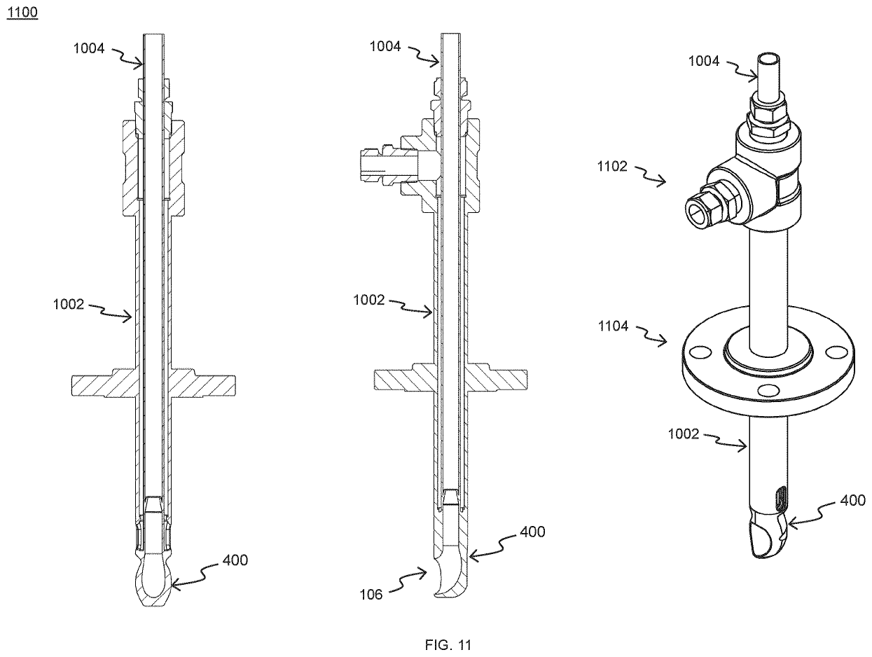

FIG. 11 shows multiple cross-sectional views and an isometric view of a flanged-style scoop probe 1100 with connected inlet pipe 1004 and outlet pipe 1002 and wherein the scoop probe connects to the process through a flange, according to an embodiment. Some embodiments may be referred to as flanged-style scoop probes; these can consist of a probe tip 400 (probe tips 100 or 700 may also be used), coaxial inlet 1004 and outlet 1002 pipes, a T fitting 1102, a flange 1104 for mounting the flanged-style scoop probe 1100 on a process, and compression fittings for connecting the flow loop to the T fitting 1102. For the 1″ pipe embodiment, the outlet pipe 1002 may be 1″ (it is advantageous for the outside diameter of the probe tip 400 to match the outside diameter of the outlet pipe 1002) schedule 40 stainless steel and the inlet tube 1004 may be ¾″ 0.065″ wall thickness tubing; however, other sizes can be used. The outlet pipe 1002 and inlet pipe 1004 sizes may be selected based on the process connection size and with the goal of having a similar cross-sectional area and flow resistance for the inside of the inlet pipe 1004 and the annular area formed by the inside of the outlet pipe 1002 and the inlet pipe 1004. The T fitting for the flanged-style scoop probe 1100 may use a socket-weld connection for the 1″ outlet pipe 1002 and two 1″ NPT threads for the compression fittings of the inlet pipe 1004, but other sizes can be used as appropriate.

For assembly, the probe tip 400 may be welded onto the outlet pipe 1002 and then welded or threaded into the T fitting 1102 as illustrated. For welding, the front opening in the inlet port 106 of the probe tip 400 may be aligned with the 90° branch opening in the T fitting 1102 to provide an orientation reference for installing the flanged-style scoop probe 1100 and verifying that it has been installed properly with the opening of the inlet port 106 of the probe tip 400 facing the process flow. Once the process connection details are known, an appropriate size-and pressure-rated reducing slip on the flange 1104 may be welded onto the outlet pipe 1102 in a position that results in the correct probe insertion depth into the process. The size of the flange 1104 may be dictated by the available process connection size and specification. Before welding the flange 1104 in place, it is important to verify the orientation of bolt holes in the process connection flange to ensure that the scoop probe 1100 can be aligned correctly when installed.

Once the welding is complete, the compression fittings and inlet tube 1104 can be installed. The inlet tube 1004 may be installed by sliding it through the upper compression fitting and aligning and pushing it down onto the tapered outlet 402 of the probe tip 400. As the compression fitting is tightened, the bottom end of the inlet tube 1104 is forced further onto the tapered outlet 402 which creates a seal.

Embodiments may also use a “tubing” style of scoop probe that is similar to the flanged-style scoop probe 1100 except the probe is mounted to the process with a compression fitting rather than a flange 1104. This probe style may be used when the process connection type is an NPT threadolet rather than a flange 1104. Tubing-style scoop probes may consist of a probe tip 100 (400 or 700), coaxial inlet 1004 and outlet 1002 pipes, a T fitting 1102, and compression fittings for mounting the scoop probe on the process and connecting the flow loop to the T fitting 1102. For a 1″ diameter version of a tubing-style scoop probe, a stainless steel outlet tube 1102 of 1″ diameter with a 0.095″ wall thickness and an inlet tube 1004 of ½″ diameter with a 0.049″ wall thickness may be used. The sizes of the outlet pipe 1002 and inlet pipe 1004 may be selected based on the process connection size and with the goal of having a similar cross-sectional area and flow resistance for the inside of the inlet pipe 1004 and the usable cross section area of the outlet pipe 100. In applications, tubing is used for the outside of the tubing-style probe instead of pipe because most commercially available compression fittings are designed for use with tubing rather than pipe.

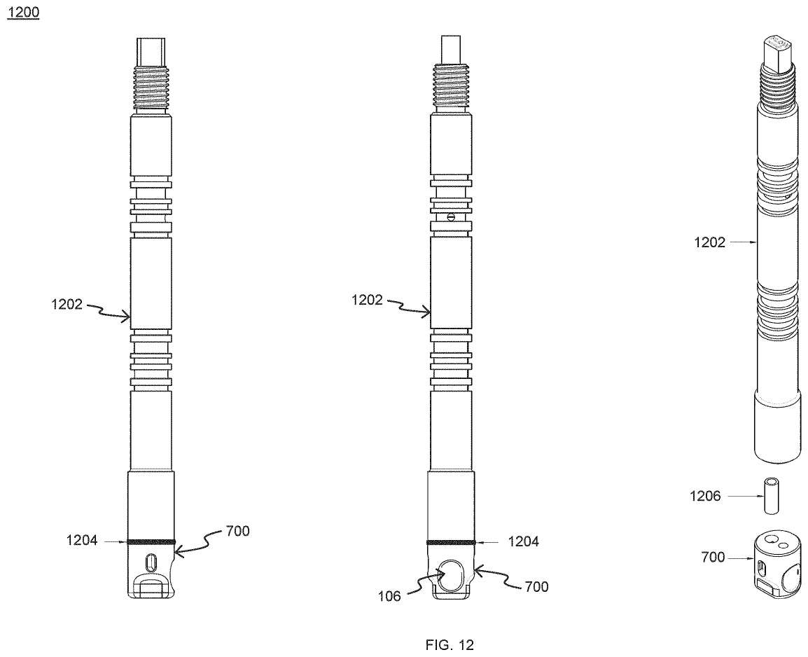

FIG. 12 shows multiple views of an NPT-style scoop probe 1200 with integrated inlet and outlet pipes, according to an embodiment. The NPT-style scoop probe 1200 includes a rotating center shaft 1202. The NPT-style scoop probe 1200 may be mounted to the process using a ½″ or larger NPT threaded connection, and instead of using a compression fitting to mount the NPT-style scoop probe 1200 on the process, the probe body (not shown) is threaded onto the process using an integrated NPT thread. Probe tip 700 may be welded to a machined shaft 1202 that fits into the probe body and can be rotated to align the opening of the inlet port 106 in the probe tip 700 so that it is facing the process flow. O-rings 1204 on the shaft provide sealing between the shaft 1202 and the probe body and allow the alignment to be done without depressurizing the process, which may not be possible with other versions of the scoop probe that mount the probe to the process with flanges 1104 or compression fittings. NPT-style scoop probe 1200 provides a simplified gas flow connection to the probe body and the possibility of using multiple valves. The NPT-style scoop probe 1200 may be formed by only welding the outlet tube 1002 to probe tip 700, with the rest of the assembly being accomplished by coupling the components together with compression fittings. It is possible to make versions of an NPT-style scoop probe 1200 that will work with ½″, ¾″, and 1″ NPT process connections using ½″, ¾″ or 1″ size tubing respectively for the outlet tube 1002. The NPT-style scoop probe 1200 further includes a connector 1206 that is pressed into both the probe tip 700 and the shaft 1202 to provide a pressure seal.

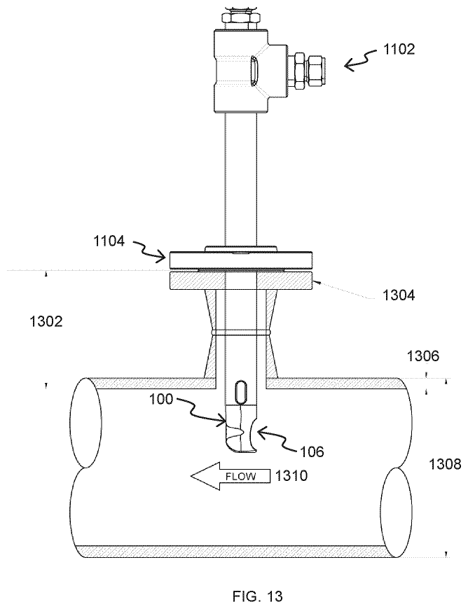

FIG. 13 illustrates a scoop probe tip assembly 1300 as used to extract a sample from a process flow, according to an embodiment. A process flows in direction 1310 within a pipe. The pipe of the process has an outside diameter 1308 and a thickness 1306. A scoop probe includes a probe tip 100 (but may also be probe tip 400 or probe tip 700). The scoop probe is installed so that the inlet port 106 of the probe tip 100 faces the process flow 1310. A flange 1104 on the scoop probe is mated with a flange 1304 on the process pipe which positions the inlet port 106 of probe tip 100 relative to vertical distance 1302. Samples collected by the scoop probe may be extracted through T fitting 1102 and analyzed before being returned to the process via the probe. In the embodiment illustrated in FIG. 13, the T fitting 1102 is aligned with the inlet port 106 for ease of orientating the inlet port 106 when the scoop probe is mounted.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. A probe tip for a sample retrieval system including an inlet pipe and an outlet pipe, the probe tip comprising:
an elongated, hollow body having a distal end, a proximal end, and a central axis;
an inlet port formed in the distal end of the body, the inlet port including an opening for facing a process flow to receive a sample of a process fluid from the process flow, the inlet port including an inlet passage directing the sample in a direction along the central axis towards a proximal portion of the inlet port, the inlet passage having a non-constant cross-sectional area with non-parallel radii of curvature defined by an outer radius and an inner radius, the outer radius being larger than the inner radius, the outer radius decreasing along a length of the inlet port from the opening to the proximal portion;
an inlet tube in fluid communication with the proximal portion of the inlet port and configured to receive the sample from the inlet port and direct the sample towards the proximal end of the body to be received by the inlet pipe;
an outlet tube connected to the proximal end of the body and configured to receive a returned portion of the sample from the outlet pipe; and
an exit port formed in the body, the exit port configured to be in fluid communication with the outlet tube to receive the returned portion of the sample from the outlet tube and expel the returned portion into the process flow in a direction away from the process flow, the exit port located at a position closer to the proximal end of the probe tip than a position of the inlet port.

2. The probe tip of claim 1 wherein the opening of the inlet port has an elliptical shape with a longer axis of the ellipse aligned with the central axis.

3. The probe tip of claim 1 wherein the inlet tube is arranged within the outlet tube.

4. The probe tip of claim 3 wherein the inlet tube and the outlet tube are in a coaxial arrangement.

5. The probe tip of claim 1 wherein the exit port is positioned on a side of the body facing away from the inlet port.

6. The probe tip of claim 1 wherein the exit port is at a position corresponding to a widest diameter of the body of the probe tip.

7. The probe tip of claim 5 further comprising an additional exit port arranged on an opposite side of the body from the exit port, wherein the additional exit port is facing away from the inlet port.

8. The probe tip of claim 7 further comprising baffles within a cross-sectional annular area between the inlet tube and the outlet tube and aligned with the central axis to prevent flow between the exit port and the additional exit port.

9. The probe tip of claim 3 wherein a cross-sectional area of the inlet tube and a cross-sectional annular area between the inlet tube and the outlet tube are similar.

10. The probe tip of claim 1 wherein a distal outer surface of the inlet port is tangential to the process flow.

11. The probe tip of claim 1 wherein a proximal end of the inlet tube is tapered to receive the inlet pipe, an inside diameter of the inlet pipe being sealed against the tapered proximal end of the inlet tube via a force from a compression fitting located at the proximal end of the inlet tube.

12. The probe tip of claim 1 wherein an outside diameter of the proximal end of the body is matched to an inside diameter of the outlet pipe.

13. A probe tip assembly comprising:
the probe tip of claim 1;
an inlet pipe attached to the inlet tube; and
an outlet pipe attached to the outlet tube.

14. The probe tip assembly of claim 13 further comprising a T fitting connected to a proximal end of the outlet pipe, a perpendicular opening of the T fitting aligned in the same plane as the opening of the inlet port of the probe tip.

15. The probe tip assembly of claim 13 further comprising a flange for securing the probe tip assembly wherein the probe tip is positioned within the process flow with the opening of the inlet port facing an opposite direction of flow of the process fluid.

16. The probe tip assembly of claim 13 further comprising a bored-through compression fitting for securing the probe tip assembly wherein the probe tip is positioned within the process flow with the opening of the inlet port facing an opposite direction of flow of the process fluid.
